(19) United States
(12) Patent Application Publication
(10) Pub. No.: US 2002/0079335 A1
(43) Pub. Date: Jun. 27, 2002

(54) Multi-port lubricant dispenser

(76) Inventor: Siegfried Kramer, Sebring, OH (US)

Correspondence Address: KEN PARKINSON, PERMAN INDUSTRIES, INC., C/O ROKEN, INC., 101 ANDIRON CIRCLE, MCMURRAY, PA, 15317, US

(21) Appl. No.: 09/747,141

(22) Filed: Dec. 22, 2000

(51) Int. Cl. B67D 5/42

(52) U.S. Cl. 222/333; 222/330; 222/390

(57) ABSTRACT

An improved motorized lubricant dispenser comprising a multi-port rotary distributor disconnectably connected to a detachable motorized lubricant dispenser. The multi-port rotary distributor is connectable to a plurality of lubrication points. The multi-port rotary distributor has a compact size and is essentially comprised of three parts: (1) a manifold; (2) a closure cap; and (3) a distributor disk. The detachable motorized lubricant dispenser has an electric motor-driven spindle that floatingly engages and rotatingly drives the distributor disk of the multi-port rotary distributor. As the distributor disk rotates, an aperture in the distributor disk successively registers with each of the discharge ports of the rotary distributor manifold to allow lubricant, which is pressurized by the advancing piston in the motorized lubricant dispenser, to flow out successively to each of the lubrication points that are connected to the multi-port rotary distributor.

### FIELD OF THE INVENTION

The invention relates to a multi-port, motorized lubricant dispenser. More particularly, the invention relates to a multi-port lubricant dispenser having a multi-port rotary distributor disconnectably connected to a detachable motorized lubricant dispenser.

### BACKGROUND

Industrial machinery, including industrial robots, commonly require the application of fluent lubricants at joints and other areas where adjacent surfaces or contact points are in contacting relative motion. Because of its great importance to industrialized society, the provision of lubricants to each point on a machine which needs to be lubricated, i.e., to “lubrication points,” is an old and crowded art.

Modernly, it is known to use self-contained, lubricant dispensers to supply lubricant to satisfy many lubrication needs. These lightweight units have the advantage of being installable local to the joint that is to be lubricated. This obviates the need to resort to either manual lubrication or the use of long lubricant distribution lines from a remote supply of lubricant.

Some of such lubricant dispensers are motorized units having a two-part housing. The lower part comprises a vessel adapted to hold a supply of lubricant on the order of a few tens to a few hundreds cubic centimeters and is formed to neck down to an outlet adapted to threadably attach to a fitting on the machine that is in communication with the lubrication point that is to be lubricated. The upper part comprises an upper housing containing an electric motor drive, a threaded spindle, and a piston arranged so that periodically energizing the electric motor drive causes the spindle to advance the piston into the lubricant reservoir of the lower part, thereby displacing lubricant from the reservoir to a lubrication point on the machine that is to be lubricated. Examples of such motorized lubricant dispensers are described in U.S. Pat. No. 5,271,528 to Chien, U.S. Pat. No. 5,634,531 to Graf et al., and U.S. Pat. No. 5,971,229 to May et al. The teachings of each of these patents are incorporated herein by reference.

Gas pressure driven lubricant dispensers are also known. The gas pressure driven units are similar to their motorized counterparts except that instead of using an electric motor drive and spindle to drive the piston that displaces the lubricant from the reservoir, the gas pressure driven units typically contain in their upper sections a two-part chemical system which, when activated, creates a gas pressure for driving the lubricant-displacing piston. Examples of gas pressure driven lubricant dispensers are described in U.S. Pat. No. 5,386,883 to Graf and U.S. Pat. No. 5,409,084 to Graf. The teachings of each of these patents are incorporated herein by reference. Many gas pressure driven lubricant dispensers, however, suffer from a deficiency not present in the motorized units in that the pressurization reaction they employ is not reversible. Thus, such a gas pressure driven unit will continue providing lubricant even when the machine is out of service, thereby wasting its lubricant, depleting its gas pressure, and possibly creating a mess of excess lubricant in the vicinity of the joint to which it is supplying lubricant.

The presently known motorized lubricant dispensers are not without their own drawbacks. One disadvantage that is of considerable importance is that a separate lubricant dispenser is needed for each lubrication point. This is problematic because it is necessary to provide clearance around and access to each lubricant dispenser. This is especially problematic when two or more lubrication points are in such close proximity to one another that there is insufficient room to install the corresponding lubricant dispensers so close to each other or when the machine's design or operation provides little space to accommodate a lubricant dispenser in the vicinity of each lubrication point. Another disadvantage is the cost of providing and maintaining a separate electric motor drive in each motorized lubricant dispenser. Yet another disadvantage is that, in some instances, a motorized lubricant dispenser may provide more lubricant than is needed by the lubrication point and cause a mess of excess lubricant in the vicinity of the lubrication point.

### SUMMARY OF THE INVENTION

The present invention overcomes the disadvantages of the prior art motorized lubricant dispensers by providing an improved multi-port lubricant dispenser comprising a multi-port rotary distributor disconnectably connected to a detachable motorized lubricant dispenser. The multi-port rotary distributor is connectable to a plurality of lubrication points. The detachable motorized lubricant dispenser has an electric motor-driven spindle that floatingly engages and rotatingly drives a distributor disk within the multi-port rotary distributor. In service, as the distributor disk rotates, an aperture in the distributor disk successively registers with each of the discharge ports of the rotary distributor manifold to allow lubricant, which is pressurized by the advancing piston in the motorized lubricant dispenser, to flow out successively to each of the lubrication points that are connected to the multi-port rotary distributor. The multi-port rotary distributor takes full advantage of the limited amount of lubricant pressure which the motorized lubricant dispenser delivers by substantially placing only one discharge port at a time in communication with the pressurized lubricant reservoir.

One of the advantages of the present invention is the space-savingly compact and simple design of the multi-port rotary distributor. The multi-port rotary distributor is essentially comprised of three parts: (1) a manifold; (2) a closure cap; and (3) a distributor disk. Although a spring may be optionally interposed between the closure cap and the distributor disk to assist in keeping the distributor disk in place, during operation it is the force of the pressurized lubricant that keeps the distributor disk seated on the manifold face.

The multi-port rotary distributor contributes very little to the overall height of the multi-port lubricant dispenser as its height is only a fraction of that of the motorized lubricant dispenser. Preferably, the axial height of the multi-port rotary distributor is about a third or less than the axial height of the motorized lubricant dispenser to which it connects. The multi-port rotary distributor also has a small maximum outside diameter which is preferably smaller than that of the maximum outside diameter of the lubricant dispenser.

The shape of the closure cap may be generally cylindrical or, more preferably, it may taper out from a narrow inlet adapted to connect to the motorized lubricant dispenser to a wider base adapted to connect to the manifold. A tapered shape for the closure cap helps to minimize the size and the mass of the multi-port distributor while promoting good flow of the lubricant. Because of the small size of the multi-port rotary distributor, the inertial mass of an improved multi-port motorized lubricant dispenser according to the present invention is comparable to that of a single conventional motorized lubricant dispenser. When it is taken into consideration that an improved multi-port lubricant dispenser according to the present invention can take the place of multiple conventional lubricant dispensers, it is clear that in applications such as robot arms where the lubricant dispenser is installed on a moving part, the present invention provides the advantage of reducing the moving mass by significantly reducing the overall inertial mass attributable to lubricant dispensers on the moving part thereby yielding energy savings and permitting the use of smaller drive units for moving the parts.

Another advantage of the present invention is the floating engagement of the spindle of the motorized lubricant dispenser with the distributor disk of the multi-port rotary distributor. By floating engagement it is meant that although the spindle positively engages the distributor disk to rotationally drive the distributor disk, the spindle does not engage the distributor disk in the axial direction in a manner which presses the distributor disk against the manifold face. Thus, the spindle length does not have to be precisely fitted to the multi-port distributor in order to avoid compromising the operation of the unit by the spindle causing the distributor disk to press too hard or not hard enough against the manifold face. This floating engagement feature of the present invention not only makes it easy to detach and reattach the motorized lubricant dispenser from the multi-port rotary distributor, for example, for the purpose of refilling the lubricant reservoir of the lubricant dispenser, but it also facilitates replacing one motorized lubricant dispenser with another since axial dimension fitting concerns are greatly reduced.

Another advantage of an improved multi-port lubricant dispenser according to the present invention is that it is less expensive to manufacture than the multiple conventional lubricant dispensers which it replaces. Yet another advantage is that, by distributing lubricant to multiple lubrication points instead of just one lubrication point, an improved multi-port lubricant dispenser according to the present invention reduces the chance that excess lubricant will be provided to any lubrication point to cause a mess of wasted lubricant.

Thus, it is an object of the present invention to provide an improved multi-port motorized lubricant dispenser that can be used in place of multiple conventional single-point lubricant dispensers, even on moving parts such as robot arms.

It is also an object of the present invention to provide an improved multi-port lubricant dispenser comprising a multi-port rotary distributor which may be left in place connected to multiple lubrication points on a machine that is to be lubricated and a detachable motorized lubricant dispenser which may be removed for refilling and reattached to the multi-port rotary distributor or be substituted for by a replacement motorized lubricant dispenser.

It is noted that the use of rotary distributors to distribute lubricant to multiple lubrication points has long been known in the art. Some examples of rotary distributors so employed are described in U.S. Pat. No. 768,529 to King, U.S. Pat. No. 1,862,164 to Sheppard, U.S. Pat. No. 1,886,067 to Moses, U.S. Pat. No. 1,887,199 to Gillam, U.S. Pat. No. 2,481,856 to Medhaug, U.S. Pat. No. 2,546,585 to Caldwell, U.S. Pat. No. 3,217,835 to Settles, U.S. Pat. No. 4,147,233 to Smith, U.S. Pat. No. 4,286,691 to Stong, and U.S. Pat. No. 5,181,585 to Braun et al. The teachings of each of these patents are incorporated herein by reference. However, one skilled in the art will recognize that what is not described by any of these patents nor is otherwise known in or suggested by the art is a multi-port motorized lubricant dispenser having all of the aforementioned features and advantages of the present invention. These and other features and advantages inherent in the subject matter claimed and disclosed will become apparent to those skilled in the art from the following detailed description of presently preferred embodiments thereof and to the appended drawings.

### BRIEF DESCRIPTION OF THE DRAWINGS

The criticality of the features and merits of the present invention will be better understood by reference to the attached drawings wherein similar reference characters denote similar elements throughout the figures. It is to be understood, however, that the drawings are designed for the purpose of illustration only and not as a definition of the limits of the present invention.

FIG. 1 is a perspective view of a multi-port lubricant dispenser according to a first embodiment of the present invention.

FIG. 2 is an exploded view of a multi-port lubricant dispenser according to a second embodiment of the present invention showing the multi-port lubricant dispenser in cross-section along an axial mid-plane.

FIG. 3 is a cross-sectional view taken along an axial mid-plane of the lower portion of the embodiment shown in FIG. 2.

FIG. 4 is a top view of the manifold of the embodiment shown in FIG. 3.

FIG. 5 is a top view of the distributor plate of the embodiment shown in FIG. 3.

### DESCRIPTION OF PREFERRED EMBODIMENTS

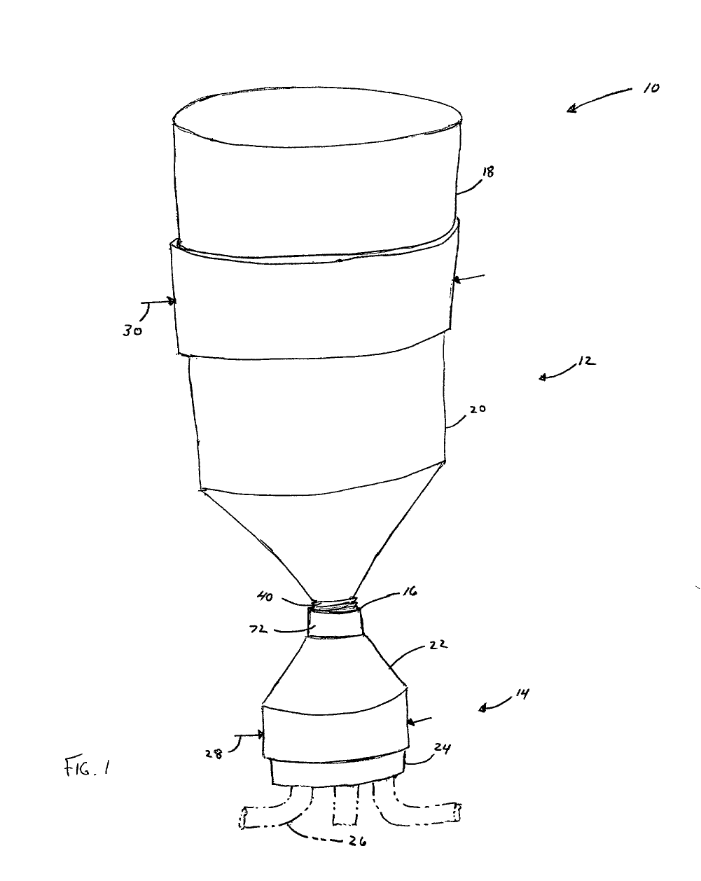

A multi-port lubricant dispenser 10 according to an embodiment of the present invention is illustrated in FIG. 1. The multi-port lubricant dispenser 10 comprises a detachable motorized lubricant dispenser 12 and a multi-port rotary distributor 14 which are threadably joined together at junction 16. Motorized lubricant dispenser 12 has a two-part housing comprising upper housing 18 and tapered lower housing 20. Multi-port rotary distributor 14 includes tapered closure cap 22 and manifold 24. Manifold 24 is adapted to receive a plurality of fittings 26 each of which communicates with a lubrication point on a machine that is to be lubricated by the multi-port lubricant dispenser 10.

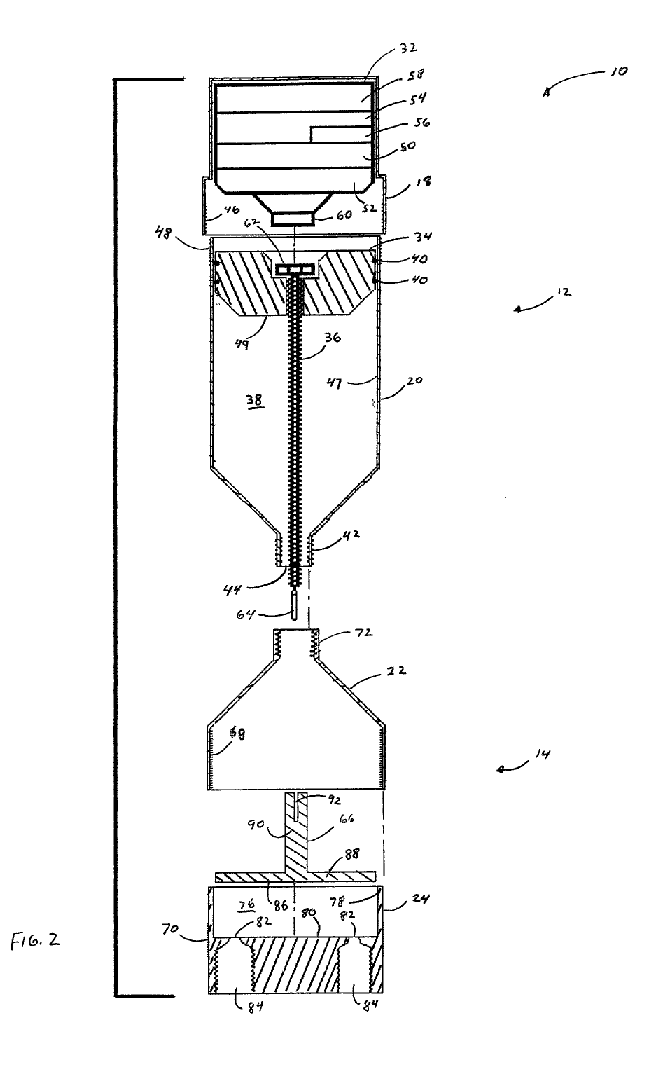

A second embodiment of a multi-port lubricant dispenser 10 according to the present invention is illustrated in FIG. 2 as an exploded view showing a cross-section thereof along an axial mid-plane. This second embodiment differs from the first embodiment shown in FIG. 1 only in that the size of the multi-port rotary distributor 14 is relatively larger in the second embodiment. In the first embodiment, the maximum outside diameter 28 of the multi-port rotary distributor 14 is shown as being smaller than the maximum outside diameter 30 of the motorized lubricant dispenser 12 whereas in the second embodiments, these diameters are shown as being about equal to each other. Because this is the only difference between these two embodiments, the same reference numerals are used in describing both embodiments without distinction.

Referring to FIG. 2, motorized lubricant dispenser 12 comprises upper housing 18, lower housing 20, electric drive unit 32, piston 34, spindle 36, lubricant reservoir 38, gaskets 40, lower housing neck 42, and reservoir outlet 44. The upper housing 18 and lower housing 20 connect together by means of upper housing inner threads 46 engaging lower housing outer threads 48. Lower housing 20 tapers down to neck 42 and terminates at reservoir outlet 44. Piston 34, which is fitted with one or more gaskets 40, is disposed within lower housing 20 so as to be axially movable therein, but is restrained from rotating by the friction between gaskets 40 and lower housing inner surface 47. Lower housing inner surface 47 and lower surface 49 of piston 34 define lubricant reservoir 38.

Electric drive unit 32, which is shown schematically, is housed within upper housing 18 and may be accessed by disconnecting upper housing 18 from lower housing 20. Electric drive unit 32 comprises an electric motor 50 and an output transmission 52 for driving spindle 36. Electric drive unit 32 optionally includes a control circuit 54 for operating the electric motor 50. The control circuit 54 preferably includes a timing circuit 56 operable to periodically activate the electric motor 50 to cause it to rotate the spindle 36. Preferably, the electric motor 50 is battery powered and electric drive unit 32 further comprises a battery 58 for powering the electric motor 50 and other electronic components of the electric drive unit 32. Power from an outside source may also be used instead of or as a supplement to battery 58.

Socket 60 of electric drive unit 32 engages faceted head 62 of spindle 36. Spindle 36 is threaded through piston 34 so that rotating spindle 36 causes piston 34 to advance into or to retreat out from lubricant reservoir 38. Advancing piston 34 into lubricant reservoir 38 displaces lubricant from lubricant reservoir 38 and causes the lubricant to flow out through reservoir outlet 44. Retreating piston 34 out from lubricant reservoir 38 permits the lubricant reservoir 38 to be refilled with lubricant. Spindle 32 extends out through reservoir outlet 44 and terminates with planar tip 64.

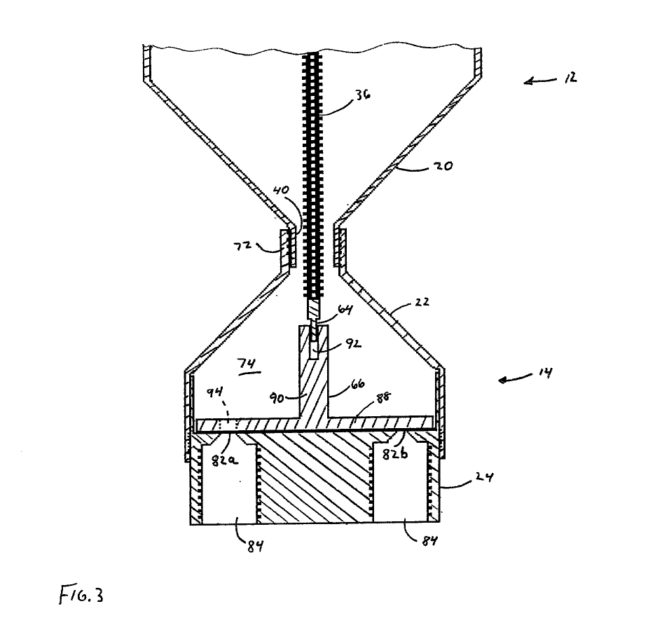

Multi-port rotary distributor 14 comprises tapered closure cap 22, distributor disk 66, and manifold 24. Preferably, each of these components is formed as a monolithic part. Closure cap 22 and manifold 24 connect together by means of closure cap inner threads 68 engaging manifold outer threads 70. Closure cap 22 narrows into closure cap neck 72 which is adapted to receive lower housing neck 42 of motorized lubricant dispenser 12. Referring to FIG. 3, closure cap 22 and manifold 24 define lubricant receiving space 74 within multi-port rotary distributor 14.

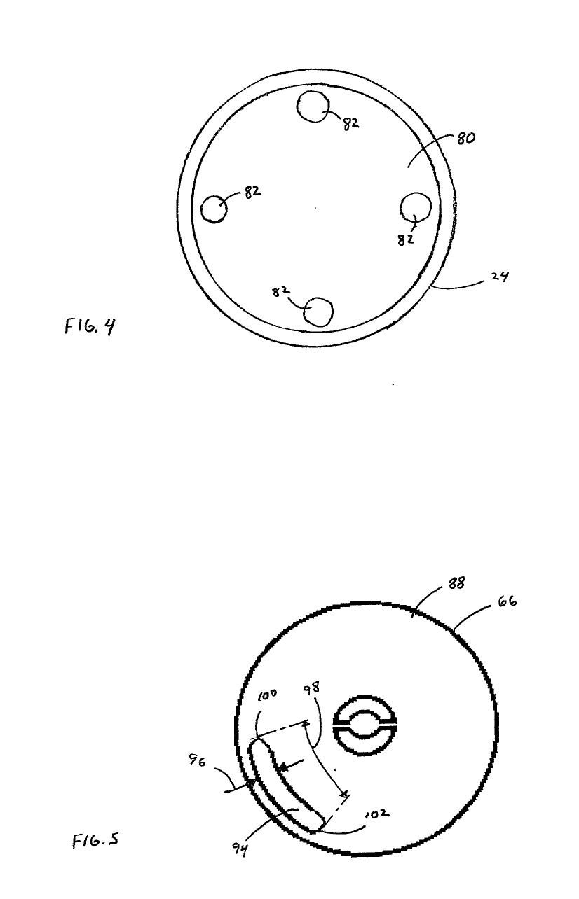

As shown in FIG. 2, manifold 24 has a cylindrical cavity 76 formed by walls 78 and manifold face 80. Referring to FIG. 4, manifold face 80 contains a plurality of openings 82. Referring now to FIG. 3, each of the openings 82 is part of one of a plurality of manifold outlets 84. Each of the manifold outlets 84 is adapted to receive a fitting or line which communicates with a lubrication point that is to be lubricated by the multi-port lubricant dispenser 10.

Referring to FIGS. 2 and 3, distributor disk 66 is positioned in cavity 76 of manifold 24 so that distributor disk lower face 86 seats upon manifold face 80. Distributor disk 66 comprises circular plate 88 and axial stem 90. It is to be understood that the circular plate 88 may be of constant or varied thickness. Axial stem 90 has at its distal end a slot 92 for receiving a planar tip 64 of spindle 36. Slot 92 and planar tip 64 cooperate to provide for floating engagement of distributor disk 66 by spindle 36. Thus, spindle 36 is able to rotatingly drive distribution disk 66 without pressing distributor lower face 86 against manifold face 80.

As shown in FIG. 5, circular plate 88 contains an aperture 94. As spindle 36 rotates distributor disk 66, aperture 94 successively registers with each of the openings 82 to place the corresponding manifold outlet 84 in fluid communication with the lubricant receiving space 74. This causes the pressurized fluent lubricant which was displaced into the lubricant receiving space 74 from lubricant reservoir 38 by the advancement of piston 34 to flow out through aperture 94 and opening 82 into the fitting or line that is attached to the corresponding manifold outlet 84 and subsequently to flow to a lubrication point. FIG. 3 shows aperture 94 in such registration with an opening 82a while the other openings 82, such as opening 82b, are closed off by circular plate 88.

Referring to FIG. 5, the dimensions of aperture 94, in particular the width 96 and arc length 98, may be chosen to regulate the amount of lubricant that is to be delivered at each registration of the aperture 94 with an opening 82. Preferably, the arc length 98 is restricted so that aperture 94 only registers with one opening 82 at a time. However, it is also contemplated that the leading edge 100 of aperture 94 may begin to register with one opening 82 before the trailing edge 102 of aperture 94 has completed its registration with the previous opening 82. This arrangement tends to keep the delivery pressure of the lubricant from pulsating during the lubrication operation.

One skilled in the art will recognize that the size and angular spacing of openings 82 will influence the amount of lubricant delivered to a corresponding lubrication point by each registration of aperture 94 with an opening 82. Although all of the openings 82 preferably are of the same size and the angular spacing between adjacent openings 82 preferably is uniform, the present invention also contemplates that the relative sizes and angular spacings may be varied to suit the needs of a particular lubrication application.

Although the dimensions and the materials of construction of the multi-port rotary distributor 14 may be varied widely depending on the application and the particular lubricant used for the application, it is preferred that the multi-port rotary distributor 14 be constructed in a manner that minimizes its cost and/or its inertial mass. Preferably, closure cap 22, distributor disk 66, and manifold 24 are made of low-cost materials, for example without limitation, plastics or metals. For example without limitation, one or more of these components may be made of steel or stainless steel. More preferably, one or more of these components is made of a low density material, for example, without limitation, aluminum or plastic.

The embodiments illustrated in FIGS. 1-3 show the lower housing 20 of the motorized lubricant dispenser 12 and the closure cap 22 of the multi-port rotary distributor 14 each to taper to a cylindrical neck, i.e., lower housing neck 42 and closure cap neck 72, respectively. It is not necessary, however, for both or either of lower housing 20 or closure cap 22 to have a cylindrical neck so long as these two components are adapted to disconnectably connect, either directly or by means of an intermediate connector, the motorized lubricant dispenser 12 to the multi-port rotary distributor 14. Additionally, although tapering of the shapes of these components is beneficial in promoting lubricant flow, these components may take on other shapes, such as, without limitation, cylindrical shapes.

The operation of a multi-port lubricant dispenser 10 according the present invention may be tailored to the application in which it is employed. Preferably, the multi-port lubricant dispenser 10 is controlled so as to periodically lubricate each of the lubrication points with which it communicates over a period of several weeks or months. It is also preferred that the electric motor 50 of the electric drive unit 32 be controlled so as to rotate the distributor disk 66 an integral number of rotations at each lubrication interval so that each lubrication point is lubricated the same number of times during each lubrication interval.

It is to be understood that other configurations of the spindle 36 and the distributor disk 66 that form a floating engagement therebetween besides the one that is described above are also within the contemplation of the present invention. For example, without limitation, the stem 90 of the distributor disk 66 may extend into the motorized lubricant dispenser 12 so that the floating engagement junction is formed in the lubricant reservoir 38 of the motorized lubricant distributor 12 or at or across the junction 16 where the lubricant dispenser 12 is connected to the multi-port distributor 14. An intermediate section may be used between the spindle 36 and the stem 90 with a floating connection being formed at either or both ends of the intermediate section. Where a stem-less distributor disk is used, the floating engagement junction may be made with the circular plate 88 itself. Furthermore, the receiving cavity need not be slot shaped as shown in FIG. 2 as slot 92, but may take on any operable shape that provides for rotational drive of the distributor disk 66 by the spindle 36 while permitting some degree of axial direction freedom. Likewise, the insertable element need not be planar shaped as shown in FIG. 2 as planar tip 64, but may be any shape which is complementary to the receiving cavity employed.

While preferred embodiments have been shown and described, various modifications and substitutions may be made thereto without departing from the spirit and scope of the invention. Accordingly, the present invention has been described by way of illustration and not limitation. Thus, it is to be distinctly understood that the present invention is not limited thereto, but may be otherwise embodied and practiced within the scope of the following claims.

What is claimed is:

1. A multi-port lubricant dispenser for lubricating a plurality of lubrication points, said multi-port lubricant dispenser comprising:
a) a motorized lubricant dispenser having an electric motor driven spindle and a reservoir for containing a lubricant; and
b) a multi-port rotary distributor having a distributor disk and a plurality of outlets; wherein said motorized lubricant dispenser is disconnectably connected to said multi-port rotary distributor, and wherein said spindle floatingly engages said distributor disk, so that said lubricant flows from said reservoir and successively into each of said plurality of outlets.

2. A multi-port lubricant dispenser as described in claim 1, wherein said distributor disk has a stem axially depending from a circular plate, said stem having a distal end, and wherein a distal end of said spindle floatingly engages said distributor disk at said distal end of said stem.

3. A multi-port lubricant dispenser as described in claim 2, wherein said distal end of said spindle has a planar tip and said distal end of said stem has a slot for receiving said planar tip.

4. A multi-port lubricant dispenser as described in claim 1, wherein said motorized lubricant dispenser is threadably connected to said multi-port rotary distributor.

5. A multi-port lubricant dispenser as described in claim 1, wherein said motorized lubricant dispenser further comprises an electric drive unit, said electric drive unit having an electric motor and a battery, said battery being electrically connected to power said electric motor.

6. A multi-port lubricant dispenser as described in claim 1, wherein said motorized lubricant dispenser further comprises an electric drive unit, said electric drive unit having an electric motor and a control circuit, and wherein said control circuit is in electronic communication with said electric motor to control said electric motor.

7. A multi-port lubricant dispenser as described in claim 6, wherein said control circuit includes a timing circuit operable to periodically activate said electric motor to rotate said spindle.

8. A multi-port lubricant dispenser as described in claim 1, wherein the maximum outside diameter of said multi-port rotary distributor is smaller than the maximum outside diameter of said motorized lubricant dispenser.

9. A multi-port lubricant dispenser as described in claim 1, wherein the axial height of said multi-port rotary distributor is no more than about a third of the axial height of said motorized lubricant dispenser.

10. A multi-port lubricant dispenser as described in claim 1, wherein said multi-port rotary distributer further comprises a closure cap and a manifold, wherein at least one of the group consisting of said distributor disk, said closure cap, and said manifold is monolithic.

11. A multi-port lubricant dispenser as described in claim 1, wherein said multi-port rotary distributer further comprises a closure cap and a manifold, wherein at least one of the group consisting of said distributor disk, said closure cap, and said manifold is made of a low density material.

12. A multi-port lubricant dispenser as described in claim 1 1, wherein said low density material comprises aluminum.

13. A multi-port lubricant dispenser as described in claim 1, wherein said multi-port rotary distributer further comprises a closure cap and a manifold, wherein at least one of the group consisting of said distributor disk, said closure cap, and said manifold is made of steel or stainless steel.

14. A multi-port lubricant dispenser as described in claim 1, wherein said multi-port rotary distributer further comprises a closure cap and a manifold, and wherein said closure cap is threadably connected to said manifold.

15. A multi-port lubricant dispenser as described in claim 1, wherein said multi-port rotary distributor further comprises a tapered closure cap.

16. A multi-port lubricant dispenser for lubricating a plurality of lubrication points, said multi-port lubricant dispenser comprising:
a) a motorized lubricant dispenser having
i) an electric drive unit;
ii) a piston;
iii) a spindle threaded through said piston, said spindle having a distal end; and
iv) a housing having a reservoir for containing a lubricant and a first outlet communicating with said reservoir; and
b) a multi-port rotary distributor having
i) a closure cap having an inlet;
ii) a distributor disk having a circular plate, said circular plate having an aperture; and
iii) a manifold having a manifold face and a plurality of second outlets, each of said second outlets having an opening through the manifold face, said distributor disk being rotatably seated on said manifold face, and said manifold connecting to said closure cap to define a lubricant receiving space;
wherein said first outlet and said inlet cooperate to disconnectably connect said motorized lubricant dispenser to said multi-port rotary distributor, and wherein said distal end of said spindle floatingly engages said distributor disk, and wherein said electric drive unit axially rotates said spindle so as to advance said piston to displace a portion of said lubricant from said reservoir out through said first outlet into said lubricant receiving space and to rotate said distributor disk so that said aperture successively registers with each of said openings in said manifold face whereby said lubricant successively flows into each of said second outlets from said lubricant receiving space.

17. A multi-port lubricant dispenser as described in claim 16, wherein said distributor disk has a stem axially depending from said circular plate, said stem having a distal end, and wherein said distal end of said spindle floatingly engages said distributor disk at said distal end of said stem.

18. A multi-port lubricant dispenser as described in claim 17, wherein said distal end of said spindle has a planar tip and said distal end of said stem has a slot for receiving said planar tip.

19. A multi-port lubricant dispenser as described in claim 16, wherein said first outlet has first threads and said inlet has second threads, said first threads engaging said second threads to disconnectably connect said motorized lubricant dispenser to said multi-port rotary distributor.

20. A multi-port lubricant dispenser as described in claim 16, wherein said electric drive unit comprises an electric motor and a battery, said battery being electrically connected to power said electric motor.

21. A multi-port lubricant dispenser as described in claim 16, wherein said electric drive unit comprises an electric motor and a control circuit, and wherein said control circuit is in electronic communication with said electric motor to control said electric motor.

22. A multi-port lubricant dispenser as described in claim 21, wherein said control circuit includes a timing circuit operable to periodically activate said electric motor to rotate said spindle.

23. A multi-port lubricant dispenser as described in claim 16, wherein the maximum outside diameter of said multi-port rotary distributor is smaller than the maximum outside diameter of said motorized lubricant dispenser.

24. A multi-port lubricant dispenser as described in claim 16, wherein the axial height of said multi-port rotary distributor is no more than about a third of the axial height of said motorized lubricant dispenser.

25. A multi-port lubricant dispenser as described in claim 16, wherein at least one of the group consisting of said closure cap, said distributor disk, and said manifold is made of a low density material.

26. A multi-port lubricant dispenser as described in claim 25, wherein said low density material comprises aluminum.

27. A multi-port lubricant dispenser as described in claim 16, wherein at least one of the group consisting of said closure cap, said distributor disk, and said manifold is made of steel or stainless steel.

28. A multi-port lubricant dispenser as described in claim 16, wherein at least one of the group consisting of said closure cap, said distributor disk, and said manifold is monolithic.

29. A multi-port lubricant dispenser as described in claim 16, further comprising at least one gasket, wherein said piston is fitted with said at least one gasket to prevent said piston from rotating within said housing.

30. A multi-port lubricant dispenser as described in claim 16, wherein said closure cap is threadably connected to said manifold.

31. A multi-port lubricant dispenser as described in claim 16, wherein said closure cap has a tapered shape.

32. A multi-port lubricant dispenser as described in claim 16, wherein said housing has a tapered shape.
